(19) United States
(12) Patent Application Publication
(10) Pub. No.: US 2011/0200880 A1
(43) Pub. Date: Aug. 18, 2011

(54) POSITIVE ELECTRODE ACTIVE MATERIAL FOR LITHIUM SECONDARY BATTERY, METHOD OF MANUFACTURING THE SAME, AND LITHIUM SECONDARY BATTERY USING THE SAME

(75) Inventor: Denis Yau Wai Yu, Kobe-shi (JP)

(73) Assignee: SANYO ELECTRIC CO., LTD., Osaka (JP)

(21) Appl. No.: 13/030,565

(22) Filed: Feb. 18, 2011

(30) Foreign Application Priority Data
Feb. 18, 2010 (JP) 2010-033766

(51) Int. Cl. H01M 4/505; H01M 4/525; B05D 5/12

(52) U.S. Cl. 429/223; 429/224; 427/77

(57) ABSTRACT

A positive electrode active material for lithium secondary batteries having a lithium-containing transition metal oxide having a layered structure and represented by the general formula Li₁₊ₓMn_{1-x-y}M_{y}O₂, where 0<x<0.33, 0<y<0.66, and M is at least one transition metal other than Mn, the lithium-containing transition metal oxide having a boron oxide layer formed on the surface thereof.

### CROSS REFERENCE TO RELATED APPLICATIONS

This application claims priority to Japanese Patent Application No. 2010-033766, filed in the Japan Patent Office on Feb. 18, 2010, which is incorporated herein by reference.

### BACKGROUND OF THE INVENTION

The present invention relates to a positive electrode active material for lithium secondary batteries, the positive electrode active material comprising a lithium-containing transition metal oxide containing Mn as a transition metal, having a layered structure, and containing excess Li. The invention also relates to a manufacturing method of the positive electrode active material and a lithium secondary battery employing the positive electrode active material.

It has been known that Mn-based layered active material represented by Li₁₊ₓMn_{1-x-y}M_{y}O₂, where M is at least one transition metal other than Mn, containing excess lithium, shows a discharge capacity of more than 200 mAh/g (see, for example, Non Patent Document 1 in the following Citation List). Containing excess lithium means x is greater than 0 in the above formula. In theory, the active material containing 1+x moles of lithium, such as the just-mentioned active material, should exhibit a higher discharge capacity than the conventional active material containing 1 mole of lithium, such as LiCoO₂. However, although the foregoing active material contains lithium in an excess amount, it has not been able to obtain a high discharge capacity.

The present inventors have studied provision of a coating layer on the foregoing active material in order to improve the discharge capacity. As to the provision of a coating layer on the surface of an active material, the following conventional techniques have been known.

Patent Document 1 and Non Patent Document 2 propose a surface treatment of LiMn₂O₄ with lithium boron oxide to improve high-temperature storage performance, but it is observed that the discharge capacity is lowered. This is believed to be because the surface area is reduced by the provision of the coating layer and consequently the reaction between the electrode and the electrolyte solution is suppressed.

Patent Document 2 discloses the addition of B₂O₃ to LiCoO₂ serves to reduce the dissolution of Co during storage and consequently suppress self-discharge.

Patent Document 3 discloses that self-discharge can be prevented and storage performance can be improved by mixing a boron-containing material with MnO₂ or a Li—Mn compound (Mn:Li=7:3) and annealing the mixture at 375° C. for 30 hours.

Patent Document 4 discloses that the thermal stability (DSC) of the active material is improved by adding lithium borate and Li₂CO₃ to a Ni—Mn—Co precursor and annealing it at 900° C. for 11 hours.

Patent Document 5 discloses that the cycle performance can be improved by mixing boron ethoxide with an active material such as LiCoO₂, a Li-containing Ni—Co—Mo oxide, and LiMn₂O₄, and annealing the mixture.

Patent Document 6 discloses that the cycle performance can be improved by mixing a hydroxide of Ni/Mn, a boron-containing material, and an appropriate amount of a Li-containing compound with LiCoO₂, then drying the mixture and thereafter annealing it at 950° C.

Patent Documents 7 and 8 describes the treatment of a Ni-based oxide material (Li_{1.03}Ni_{0.77}Co_{0.20}Al_{0.03}O₂) with (NH₄)₂.5B₂O₃.8H₂O, Li₂B₄O₇, and LiBO₂. These publications describe that when the material is treated at 700° C., the discharge capacity can be increased, but when treated at 500° C., the discharge capacity is decreased. This is believed to be because of an increase of the BET specific surface area.

As described above, no prior art document has disclosed a technique for improving the discharge capacity of the lithium-containing transition metal oxide containing Mn as a transition metal, having a layered structure, and containing excess lithium.

### CITATION LIST

### Patent Literature

[Patent Document 1] U.S. Pat. No. 5,705,291
[Patent Document 2] Japanese Published Unexamined Patent Application No. 2008-91196
[Patent Document 3] Japanese Published Unexamined Patent Application No. 9-115515
[Patent Document 4] Japanese Published Unexamined Patent Application No. 2004-335278
[Patent Document 5] Japanese Published Unexamined Patent Application No. 2009-152214
[Patent Document 6] Japanese Published Unexamined Patent Application No. 2008-16236
[Patent Document 7] Japanese Published Unexamined Patent Application No. 2009-146739
[Patent Document 8] Japanese Published Unexamined Patent Application No. 2009-146740

### Non Patent Literature

[Non Patent Document 1] Y. Wu and A. Manthiram, “High Capacity, Surface Modified Layered Li[Li_{(1-x)/3}Mn_{(2-x)/3}Ni_{x/3}Co_{x/3}]O₂ Cathodes with Low Irreversible Capacity Loss,” Electrochemical and Solid State Letters 9, A221-A224 (2006).
[Non Patent Document 2] G. G. Amatucci, A. Blyr, C. Sigala, P. Alfonse, and J. M. Tarascon, “Surface treatments of Li₁₊ₓMn₂₋ₓO₄ spinels for improved elevated temperature performance”, Solid State Ionics, 104, 13-25 (1997).

### SUMMARY OF INVENTION

It is an object of the present invention to provide a positive electrode active material for lithium secondary batteries having a high discharge capacity, with a positive electrode active material that comprises a lithium-containing transition metal oxide containing Mn as a transition metal, having a layered structure, and containing excess lithium, and also to provide a manufacturing method of the positive electrode active material and a lithium secondary battery employing the positive electrode active material.

The present invention provides a positive electrode active material for lithium secondary batteries, comprising a lithium-containing transition metal oxide having a layered structure and represented by the general formula Li₁₊ₓMn_{1-x-y}M_{y}O₂, where 0<x<0.33, 0<y<0.66, and M is at least one transition metal other than Mn, the lithium-containing transition metal oxide having a boron oxide layer formed on a surface thereof.

The positive electrode active material of the present invention uses a lithium-containing transition metal oxide containing Mn as a transition metal, having a layered structure, and containing excess lithium. Nevertheless, high discharge capacity can be obtained because a boron oxide layer is formed on the surface thereof.

In the present invention, it is preferable that 1−x−y in the general formula be in the range of 0.4<1−x−y<1. In other words, it is preferable that the content of Mn among the transition metals be within the range of from 0.4 to 1 in the lithium-containing transition metal oxide. In the present invention, it is the interaction between Mn and B that serves to increase the discharge capacity. Therefore, if the content of Mn is too low, the advantageous effect is lessened.

In the general formula, M represents at least one transition metal other than Mn. Examples include Co, Ni, Fe, Ti, Cr, Zr, Nb, Mo, Mg, and Al. Especially preferable among them are Co and Ni. When M is Co and Ni, it is preferable that the lithium-containing transition metal oxide be represented by the general formula Li₁₊ₓMn_{1-x-p-q}CoₚNi_{q}O₂, where 0<x<0.33, 0<p<0.33, and 0<q<0.33.

It is preferable that x in the general formula be in the range of 0.1≦x≦0.30. The just-described lithium-containing transition metal oxide may be represented as rLi₂MnO₃+sLiMO₂, where r and s are in the range of 1<2r+s<1.33. Accordingly, when x is the foregoing range, the utilization rate of Li₂MnO₃ is increased, so the discharge capacity is increased.

In the present invention, it is preferable that the amount of the boron oxide layer in terms of B₂O₃ be within the range of from 0.1 to 5 parts by mass with respect to 100 parts by mass of the lithium-containing transition metal oxide. If the amount of the boron oxide layer is too small, the effect of increasing the discharge capacity according to the invention may not be obtained sufficiently. On the other hand, if the amount of the boron oxide layer is too large, the relative content of the lithium-containing transition metal oxide in the positive electrode active material decreases, so the discharge capacity may be lowered. It is more preferable that the amount of the boron oxide layer be in the range of from 0.2 to 4 parts by mass, still more preferably from 0.5 to 3 parts by mass.

In the present invention, it is preferable that the lithium-containing transition metal oxide have a space group C2/m or C2/c.

In the present invention, it is preferable that the boron oxide layer be formed by heat-treating a boron-containing compound. It is preferable that the temperature of the heat treatment be within the range of from 200° C. to 500° C., more preferably from 300° C. to 400° C. An even higher discharge capacity can be obtained by setting the temperature of the heat treatment within the just-described ranges.

The method of manufacturing a positive electrode active material according to the invention is a method that can manufacture a positive electrode active material for lithium secondary batteries according to the invention as described above, and the method includes: preparing the lithium-containing transition metal oxide represented by the foregoing general formula; causing a boron-containing compound to adhere to a surface of the lithium-containing transition metal oxide; and heat-treating the lithium-containing transition metal oxide to which the boron-containing compound has been adhered, to form a boron oxide layer on the surface of the lithium-containing transition metal oxide.

Examples of the boron-containing compound include H₃BO₃, B₂O₃, LiBO₂, and Li₂B₄O₇. It is especially preferable that the boron-containing compound be at least one of H₃BO₃ and B₂O₃.

The boron-containing compound may be caused to adhere to the surface of the lithium-containing transition metal oxide by mixing a solution containing the boron-containing compound with the lithium-containing transition metal oxide and thereafter drying the mixture. When the boron-containing compound is a compound such as B₂O₃ that does not dissolve in a solvent such as water, the boron-containing compound may be caused to adhere to the surface of the lithium-containing transition metal oxide by mixing particles of boron-containing compound with the lithium-containing transition metal oxide. In this case, it is preferable that the particles of the boron-containing compound have an average particle size of from 0.1 μm to 10 μm.

In addition, it is preferable that the lithium-containing transition metal oxide have an average particle size of from 0.5 μm to 30 μm.

In the method of manufacturing a positive electrode active material for lithium secondary batteries according to the present invention, the boron-containing compound is caused to adhere to the surface of the lithium-containing transition metal oxide, and thereafter the heat treatment is conducted. By the heat treatment, the boron oxide layer can be formed on the surface of the lithium-containing transition metal oxide. The composition of the boron oxide layer is not limited to B₂O₃, but may be another boron oxide composition as long as the layer is composed of a compound containing boron and oxygen. For example, when the layer is formed from H₃BO₃ or the like, H may remain in the boron oxide layer.

When causing B₂O₃ to adhere to the surface of the lithium-containing transition metal oxide, it is possible to form a layer in which particles of B₂O₃ is sintered by heat-treating B₂O₃.

In the present invention, it is unnecessary that the boron oxide layer cover the entire particle of the lithium-containing transition metal oxide. It is sufficient that the boron oxide layer cover at least a portion of the surface of the lithium-containing transition metal oxide.

The lithium secondary battery according to the present invention may include a positive electrode, a negative electrode, and a non-aqueous electrolyte, and the positive electrode may contain the foregoing positive electrode active material according to the invention.

The lithium secondary battery according to the present invention shows a high discharge capacity because it employs the foregoing positive electrode active material according to the present invention.

Examples of the solvent of the non-aqueous electrolyte used in the present invention include cyclic carbonic esters, chain carbonic esters, esters, cyclic ethers, chain ethers, nitriles, and amides.

Examples of the cyclic carbonic esters include ethylene carbonate, propylene carbonate, and butylenes carbonate. It is also possible to use a cyclic carbonic ester in which part or all of the hydrogen groups of one of the foregoing cyclic carbonic esters is/are fluorinated. Examples include trifluoropropylene carbonate and fluoroethylene carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile. Examples of the amides include dimethylformamide.

In the present invention, the non-aqueous solvent may be at least one of the foregoing examples.

The electrolyte that is added to the non-aqueous solvent may be any lithium salt that is commonly used in conventional lithium secondary batteries. Examples include LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (where l and m are integers equal to or greater than 1), LiC(CₚF₂ₚ₊SO₂)(C_{q}F_{2q+1}SO₂)(CᵣF₂ᵣ₊₁SO₂) (where p, q, and r are integers equal to or greater than 1), Li[B(C₂O₄)₂] (lithium bis(oxalato)borate (LiBOB)), Li[B(C₂O₄)F₂], Li[P(C₂O₄)F₄], and Li[P(C₂O₄)₂F₂]. These lithium salts may be used either alone or in combination.

It is preferable to use a material capable of intercalating and deintercalating lithium as the negative electrode active material. Examples include metallic lithium, lithium alloys, carbonaceous substances, and metallic compounds. These negative electrode active materials may be used either alone or in combination.

Examples of the lithium alloys include lithium-aluminum alloy, lithium-silicon alloy, lithium-tin alloy, and lithium-magnesium alloy.

Examples of the carbonaceous substances capable of intercalating and deintercalating lithium include natural graphite, artificial graphite, coke, vapor grown carbon fibers, mesophase pitch-based carbon fibers, spherical carbon, and resin-sintered carbon.

A lithium secondary battery with a high discharge capacity can be obtained by using the positive electrode active material for lithium secondary batteries according to the present invention.

The manufacturing method according to the present invention makes it possible to manufacture the above-described positive electrode active material for lithium secondary batteries in an efficient manner.

The lithium secondary battery according to the present invention achieves a high discharge capacity because it employs the positive electrode active material for lithium secondary batteries according to the present invention.

### DESCRIPTION OF EMBODIMENTS

Hereinbelow, the present invention is described in further detail based on examples thereof. It should be construed, however, that the present invention is not limited to the following examples.

### Experiment 1

### Preparation of Lithium-Containing Transition Metal Oxide

Lithium hydroxide (LiOH) and a coprecipitated hydroxide of Mn, Co, and Ni were used as the starting materials. These materials were mixed so as to be in a predetermined composition ratio, and the mixed powder was formed into pellets. The resulting pellets were sintered at 900° C. for 24 hours. Thereby, a lithium-containing transition metal oxide having the composition Li_{1.2}Mn_{0.54}Co_{0.13}Ni_{0.13}O₂ was obtained. The average particle size of the resultant lithium-containing transition metal oxide was 11 μm.

### Preparation of Positive Electrode Active Material

A boron oxide layer was formed on the surface of the resultant lithium-containing transition metal oxide as will be described in the following Examples, to prepare a positive electrode active material.

In Comparative Examples, the lithium-containing transition metal oxide was heat-treated at a predetermined temperature without forming the boron oxide layer on the surface thereof, and the resulting material was used as the positive electrode active material.

### Preparation of Positive Electrode

The positive electrode active material obtained in the above-described manner was mixed with acetylene black as a conductive agent and polyvinylidene fluoride (PVdF) as a binder at a weight ratio of 80:10:10. Next, NMP (N-methyl-2-pyrrolidone) was added to the resultant mixture and mixed together to prepare a slurry.

The resultant slurry was coated onto an aluminum foil using a coater and dried at 110° C. using a hot plate. Thus, a positive electrode was prepared.

### Preparation of Lithium Secondary Battery

Using the positive electrode prepared in the foregoing manner, a test cell was prepared as a lithium secondary battery. The test cell was prepared by using Li metal as the negative electrode and disposing a separator between the positive electrode and the negative electrode. The non-aqueous electrolyte solution used was an electrolyte solution in which LiPF₆ (lithium hexafluorophosphate lithium) was added at a concentration of 1 M (mole/liter) to a mixed solvent of 3:7 volume ratio of ethylene carbonate and diethyl carbonate.

### Evaluation of Lithium Secondary Battery

Test cells obtained according to the above-described manner were charged and discharged between 2 V and 4.8 V, and the test cells were evaluated. The current in the charge-discharge operation was set at 20 mA/g.

The discharge capacity at the first cycle and the charge-discharge efficiency at the first cycle were measured for each of the test cells.

### Examples 1 to 5

On the surface of the lithium-containing transition metal oxide obtained in the above-described manner, a boron oxide layer was formed in the following manner.

2 parts by mass of H₃BO₃ and 50 parts by mass of water were prepared with respect to 100 parts by mass of the lithium-containing transition metal oxide, and the resultant aqueous solution was mixed with the lithium-containing transition metal oxide. Next, this mixture was dried in the air at 80° C. Subsequently, the dried powder was heat-treated in the air for 5 hours at a predetermined temperature for each example. The heating temperatures were set at 200° C. (for Example 1), 300° C. (for Example 2), 400° C. (for Example 3), 500° C. (for Example 4), and 600° C. (for Example 5).

For each example, a boron oxide layer was formed on the surface of the lithium-containing transition metal oxide in the just-described manner, and the resultant material was used as the positive electrode active material. The results of evaluation for the test cells using these positive electrode active materials are shown in Table 1 below.

### Comparative Examples 1 to 3

For comparison, a positive electrode active material was prepared by subjecting the lithium-containing transition metal oxide to a heat treatment at a predetermined temperature for each of Comparative Examples without forming the boron oxide layer on the surface of the lithium-containing transition metal oxide. The temperatures of the heat treatment were set at 300° C. for Comparative Example 1, 400° C. for Comparative Example 2, and 500° C. for Comparative Example 3. The duration of the heat treatment was 5 hours, as in the foregoing examples.

The results of evaluation for the test cells using the positive electrode active materials of Comparative Examples 1 to 3 are also shown in Table 1 below.

TABLE 1

| | | | | Amount of | |
|---|---|---|---|---|---|
| | | | | boron | Discharge |
| | | | | oxide layer | capacity at |
| | | | Heat | (in terms of | the first |
| | Lithium-containing | Coating | treatment | B₂O₃: parts | cycle |
| | transition metal oxide | treatment agent | temperature | by mass) | (mAh/g) |
| Ex. 1 | Li_{1.2}Mn_{0.54}Co_{0.13}Ni_{0.13}O₂ | 2 parts by mass | 200° C. | 1.13 | 247.1 |
| | | H₃BO₃ | | | |
| Ex. 2 | Li_{1.2}Mn_{0.54}Co_{0.13}Ni_{0.13}O₂ | 2 parts by mass | 300° C. | 1.13 | 258.9 |
| | | H₃BO₃ | | | |
| Ex. 3 | Li_{1.2}Mn_{0.54}Co_{0.13}Ni_{0.13}O₂ | 2 parts by mass | 400° C. | 1.13 | 252.6 |
| | | H₃BO₃ | | | |
| Ex. 4 | Li_{1.2}Mn_{0.54}Co_{0.13}Ni_{0.13}O₂ | 2 parts by mass | 500° C. | 1.13 | 243.8 |
| | | H₃BO₃ | | | |
| Ex. 5 | Li_{1.2}Mn_{0.54}Co_{0.13}Ni_{0.13}O₂ | 2 parts by mass | 600° C. | 1.13 | 234.5 |
| | | H₃BO₃ | | | |
| Comp. | Li_{1.2}Mn_{0.54}Co_{0.13}Ni_{0.13}O₂ | — | 300° C. | 0 | 245.5 |
| Ex. 1 | | | | | |
| Comp. | Li_{1.2}Mn_{0.54}Co_{0.13}Ni_{0.13}O₂ | — | 400° C. | 0 | 246.9 |
| Ex. 2 | | | | | |
| Comp. | Li_{1.2}Mn_{0.54}Co_{0.13}Ni_{0.13}O₂ | — | 500° C. | 0 | 239.7 |
| Ex. 3 | | | | | |

As shown in Table 1, Examples 2 to 4, in which a boron oxide layer was formed on the surface according to the present invention, exhibited higher discharge capacities at the first cycle than Comparative Examples 1 to 3, which were heat-treated at the respective heating temperatures without forming the boron oxide layer.

### Examples 6 and 7

Positive electrode active materials were prepared in the same manner as described in Example 2, except that the amount of H₃BO₃ in the H₃BO₃ aqueous solution to be mixed with the lithium-containing transition metal oxide was set at 1 parts by mass (for Example 6) and 3 parts by mass (for Example 7) with respect to 100 parts by mass of the lithium-containing transition metal oxide. Using the obtained positive electrode active materials, test cells were prepared. The amount of water in the H₃BO₃ aqueous solution was set at 50 parts by mass, as in Example 2.

The results of the evaluation for the test cells are shown in Table 2 below. Table 2 also shows the results for Example 2 and Comparative Example 1.

TABLE 2

| | | | | Amount of | |
|---|---|---|---|---|---|
| | | | | boron | Discharge |
| | | | | oxide layer | capacity at |
| | | | Heat | (in terms of | the first |
| | Lithium-containing | Coating | treatment | B₂O₃: parts | cycle |
| | transition metal oxide | treatment agent | temperature | by mass) | (mAh/g) |
| Comp. | Li_{1.2}Mn_{0.54}Co_{0.13}Ni_{0.13}O₂ | | 300° C. | 0 | 245.5 |
| Ex. 1 | | | | | |
| Ex. 6 | Li_{1.2}Mn_{0.54}Co_{0.13}Ni_{0.13}O₂ | 1 part by mass | 300° C. | 0.56 | 257.0 |
| | | H₃BO₃ | | | |
| Ex. 2 | Li_{1.2}Mn_{0.54}Co_{0.13}Ni_{0.13}O₂ | 2 parts by mass | 300° C. | 1.13 | 258.9 |
| | | H₃BO₃ | | | |
| Ex. 7 | Li_{1.2}Mn_{0.54}Co_{0.13}Ni_{0.13}O₂ | 3 parts by mass | 300° C. | 1.69 | 253.5 |
| | | H₃BO₃ | | | |

As shown in Table 2, the discharge capacity at the first cycle was increased in the examples according to the invention even when the amount of the boron oxide layer formed on the surface of the lithium-containing transition metal oxide was varied to 0.56 parts by mass or 1.69 parts by mass.

### Examples 8 to 10

In these examples, B₂O₃ was used as the material for forming the boron oxide layer. Since B₂O₃ does not dissolve in the solvent, B₂O₃ in the form of particles was mixed with the lithium-containing transition metal oxide. The B₂O₃ particles used had an average particle size of 1 μm.

The B₂O₃ particles were mixed with the lithium-containing transition metal oxide in amounts of 1 part by mass (for Examples 8 and 10) and 2 parts by mass (for Example 9) with respect to 100 parts by mass of the lithium-containing transition metal oxide, and thereafter the mixtures were heat-treated for 5 hours at 300° C. for Examples 8 and 9, and at 600° C. for Example 10. Thus, positive electrode active materials in each of which had a boron oxide layer formed on the surface thereof were obtained.

Using the obtained positive electrode active materials, positive electrodes were prepared, and using the resultant positive electrodes, test cells were prepared. The prepared test cells were evaluated in the same manner as described in the foregoing. The results of the evaluation are shown in Table 3. Table 3 also shows the results for Comparative Example 1.

TABLE 3

| | | | | Amount of | |
|---|---|---|---|---|---|
| | | | | boron | Discharge |
| | | | | oxide layer | capacity at |
| | | | Heat | (in terms of | the first |
| | Lithium-containing | Coating | treatment | B₂O₃: parts | cycle |
| | transition metal oxide | treatment agent | temperature | by mass) | (mAh/g) |
| Ex. 8 | Li_{1.2}Mn_{0.54}Co_{0.13}Ni_{0.13}O₂ | 1 part by mass | 300° C. | 1 | 248.0 |
| | | B₂O₃ | | | |
| Ex. 9 | Li_{1.2}Mn_{0.54}Co_{0.13}Ni_{0.13}O₂ | 2 parts by mass | 300° C. | 2 | 248.3 |
| | | B₂O₃ | | | |
| Ex. 10 | Li_{1.2}Mn_{0.54}Co_{0.13}Ni_{0.13}O₂ | 1 part by mass | 600° C. | 1 | 239.2 |
| | | B₂O₃ | | | |
| Comp. | Li_{1.2}Mn_{0.54}Co_{0.13}Ni_{0.13}O₂ | — | 300° C. | 0 | 245.5 |
| Ex. 1 | | | | | |

As shown in Table 3, even when B₂O₃ was used as the coating treatment agent, the test cells according to the invention exhibited higher discharge capacities at the first cycle than Comparative Example 1, in which the boron oxide layer was not formed.

### Experiment 2

### Preparation of Lithium-Containing Transition Metal Oxide

A lithium-containing transition metal oxide having the composition Li_{1.04}Mn_{0.32}Co_{0.32}Ni_{0.32}O₂ was prepared in the same manner as described in Experiment 1 above, except that a coprecipitated hydroxide with a varied composition ratio of Mn, Co, and Ni was prepared as in the preparation of the lithium-containing transition metal oxide in Experiment 1, and the resultant coprecipitated hydroxide and lithium hydroxide were mixed at a predetermined composition ratio.

### Preparation of Positive Electrode

### Examples 11, 12 and Comparative Example 4

Using H₃BO₃ as the coating treatment agent, the lithium-containing transition metal oxide was mixed with aqueous solutions containing H₃BO₃ in amounts of 1 part by mass (for Example 11) and 2 parts by mass (for Example 12) with respect to 100 parts by mass of the lithium-containing transition metal oxide. The mixtures were dried at 80° C. and thereafter heat-treated in the air at 300° C. for 5 hours. Thus, positive electrode active materials of Examples 11 and 12 were obtained.

For comparison, the lithium-containing transition metal oxide without being treated was used as the positive electrode active material (Comparative Example 4).

Using the obtained positive electrode active materials, positive electrodes were prepared, and using the resultant positive electrodes, test cells were prepared. The prepared test cells were evaluation in the same manner as described above. The results of the evaluation are shown in Table 4 below.

TABLE 4

| | | | | Amount of | |
|---|---|---|---|---|---|
| | | | | boron | Discharge |
| | | | | oxide layer | capacity at |
| | | | Heat | (in terms of | the first |
| | Lithium-containing | Coating | treatment | B₂O₃: parts | cycle |
| | transition metal oxide | treatment agent | temperature | by mass) | (mAh/g) |
| Comp. | Li_{1.04}Mn_{0.32}Co_{0.32}Ni_{0.32}O₂ | — | — | 0 | 197.1 |
| Ex. 4 | | | | | |
| Ex. 11 | Li_{1.04}Mn_{0.32}Co_{0.32}Ni_{0.32}O₂ | 1 parts by mass | 300° C. | 0.56 | 201.9 |
| | | H₃BO₃ | | | |
| Ex. 12 | Li_{1.04}Mn_{0.32}Co_{0.32}Ni_{0.32}O₂ | 2 part by mass | 300° C. | 1.13 | 201.2 |
| | | H₃BO₃ | | | |

As shown in Table 4, Examples 11 and 12, in which the boron oxide layer was formed on the surface of the lithium-containing transition metal oxide, according to the present invention, exhibited higher discharge capacities at the first cycle than Comparative Example 4, in which the boron oxide layer was not formed.

### Reference Experiment

### Comparative Example 5

Using a commercially-available spinel LiMn₂O₄ as the positive electrode active material, a test cell was prepared in the same manner as described in the foregoing. The results of evaluation for the test cell are shown in Table 5 below.

### Comparative Example 6

The spinel LiMn₂O₄ as used in Comparative Example 5 was used as the lithium-containing transition metal oxide, and a boron oxide layer was formed on the surface of the lithium-containing transition metal oxide in the same manner as used for Example 2, using H₃BO₃ as the coating treatment agent.

Using the positive electrode obtained in the just-described manner, a test cell was prepared in the foregoing manner The results of evaluation for the test cell are also shown in Table 5 below.

TABLE 5

| | | | | Amount of | |
|---|---|---|---|---|---|
| | | | | boron | Discharge |
| | | | | oxide layer | capacity at |
| | | | Heat | (in terms of | the first |
| | Lithium-containing | Coating | treatment | B₂O₃: parts | cycle |
| | transition metal oxide | treatment agent | temperature | by mass) | (mAh/g) |
| Comp. | LiMn₂O₄ | — | — | 0 | 110.5 |
| Ex. 5 | | | | | |
| Comp. | LiMn₂O₄ | 2 part by mass | 300° C. | 1.13 | 102.7 |
| Ex. 6 | | H₃BO₃ | | | |

As indicated in Table 5, in the case where LiMn₂O₄ was used as the lithium-containing transition metal oxide, the discharge capacity at the first cycle was not improved even when the boron oxide was formed on the surface thereof. It should be noted that this reference experiment is a replication of the technique disclosed in Patent Document 1.

Thus, it is demonstrated that the advantageous effects of the present invention are unique to the lithium-containing transition metal oxide specified in the present invention.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A positive electrode active material for lithium secondary batteries, comprising a lithium-containing transition metal oxide having a layered structure and represented by the general formula Li₁₊ₓMn_{1-x-y}M_{y}O₂, where 0<x<0.33, 0<y<0.66, and M is at least one transition metal other than Mn, the lithium-containing transition metal oxide having a boron oxide layer formed on a surface thereof.

2. The positive electrode active material for lithium secondary batteries according to claim 1, wherein 1−x−y in the general formula is within the range of 0.4<1−x−y<1.

3. The positive electrode active material for lithium secondary batteries according to claim 1, wherein M in the general formula consists of Co and Ni, and the lithium-containing transition metal oxide is represented by the general formula Li₁₊ₓMn_{1-x-p-q}CoₚNi_{q}O₂, where 0<x<0.33, 0<p<0.33, and 0<q<0.33.

4. The positive electrode active material for lithium secondary batteries according to claim 2, wherein M in the general formula consists of Co and Ni, and the lithium-containing transition metal oxide is represented by the general formula Li₁₊ₓMn_{1-x-p-q}CoₚNi_{q}O₂, where 0<x<0.33, 0<p<0.33, and 0<q<0.33.

5. The positive electrode active material for lithium secondary batteries according to claim 1, wherein x in the general formula is within the range of 0.1≦x≦0.30.

6. The positive electrode active material for lithium secondary batteries according to claim 2, wherein x in the general formula is within the range of 0.1≦x≦0.30.

7. The positive electrode active material for lithium secondary batteries according to claim 3, wherein x in the general formula is within the range of 0.1≦x≦0.30.

8. The positive electrode active material for lithium secondary batteries according to claim 4, wherein x in the general formula is within the range of 0.1≦x≦0.30.

9. The positive electrode active material for lithium secondary batteries according to claim 1, wherein the amount of the boron oxide layer in terms of B₂O₃ is within the range of from 0.1 to 5 parts by mass with respect to 100 parts by mass of the lithium-containing transition metal oxide.

10. The positive electrode active material for lithium secondary batteries according to claim 2, wherein the amount of the boron oxide layer in terms of B₂O₃ is within the range of from 0.1 to 5 parts by mass with respect to 100 parts by mass of the lithium-containing transition metal oxide.

11. The positive electrode active material for lithium secondary batteries according to claim 3, wherein the amount of the boron oxide layer in terms of B₂O₃ is within the range of from 0.1 to 5 parts by mass with respect to 100 parts by mass of the lithium-containing transition metal oxide.

12. The positive electrode active material for lithium secondary batteries according to claim 4, wherein the amount of the boron oxide layer in terms of B₂O₃ is within the range of from 0.1 to 5 parts by mass with respect to 100 parts by mass of the lithium-containing transition metal oxide.

13. The positive electrode active material for lithium secondary batteries according to claim 5, wherein the amount of the boron oxide layer in terms of B₂O₃ is within the range of from 0.1 to 5 parts by mass with respect to 100 parts by mass of the lithium-containing transition metal oxide.

14. The positive electrode active material for lithium secondary batteries according to claim 6, wherein the amount of the boron oxide layer in terms of B₂O₃ is within the range of from 0.1 to 5 parts by mass with respect to 100 parts by mass of the lithium-containing transition metal oxide.

15. The positive electrode active material for lithium secondary batteries according to claim 1, wherein the lithium-containing transition metal oxide has a space group C2/m or C2/c.

16. The positive electrode active material for lithium secondary batteries according to claim 1, wherein the boron oxide layer is formed by heat-treating a boron-containing compound.

17. The positive electrode active material for lithium secondary batteries according to claim 16, wherein the temperature of the heat treatment is within the range of from 200° C. to 500° C.

18. A method of manufacturing a positive electrode active material for lithium secondary batteries according to claim 1, comprising the step of:
preparing the lithium-containing transition metal oxide represented by the general formula;
causing a boron-containing compound to adhere to a surface of the lithium-containing transition metal oxide; and
heat-treating the lithium-containing transition metal oxide to which the boron-containing compound has been adhered, to form a boron oxide layer on the surface of the lithium-containing transition metal oxide.

19. The method according to claim 18, wherein the boron-containing compound is at least one of H₃BO₃ and B₂O₃.

20. A lithium secondary battery comprising a positive electrode, a negative electrode, and a non-aqueous electrolyte, the positive electrode containing a positive electrode active material according to claim 1.
